(19) United States
(12) Patent Application Publication
(10) Pub. No.: US 2022/0274460 A1
(43) Pub. Date: Sep. 1, 2022

(54) INFORMATION PROCESSING APPARATUS, INFORMATION PROCESSING METHOD AND STORAGE MEDIUM

(71) Applicant: TOYOTA JIDOSHA KABUSHIKI KAISHA, Toyota-shi (JP)

(72) Inventors: Hiroyasu HADANO, Toyota-shi (JP); Takaaki INOKUCHI, Nagoya-shi (JP); Kunihiro MURAKAMI, Okazaki-shi (JP)

(73) Assignee: TOYOTA JIDOSHA KABUSHIKI KAISHA, Toyota-shi (JP)

(21) Appl. No.: 17/672,851

(22) Filed: Feb. 16, 2022

(30) Foreign Application Priority Data
Mar. 1, 2021 (JP) 2021-031421

(51) Int. Cl. B60H 1/00

(52) U.S. Cl. CPC B60H 1/00778; B60H 1/00742; B60H 1/00657

(57) ABSTRACT

An information processing apparatus for controlling air conditioning for a predetermined vehicle, the information processing apparatus comprises a controller configured to execute: starting an air-conditioning mode which is a mode for causing air conditioning to operate in a state in which travel is prohibited, based on a request transmitted from a first apparatus; causing the air-conditioning mode to end when a first period passes; and extending the first period when a predetermined condition is satisfied in the vehicle.

### CROSS REFERENCE TO THE RELATED APPLICATION

This application claims the benefit of Japanese Patent Application No. 2021-031421, filed on Mar. 1, 2021, which is hereby incorporated by reference herein in its entirety.

### BACKGROUND

### Technical Field

The present disclosure relates to air-conditioning control of a vehicle.

### Description of the Related Art

There are systems for remotely controlling a vehicle. For example, Japanese Patent Laid-Open No. 10-053109 discloses a remote system that performs start and stop of an engine, locking and unlocking of a door, and the like based on signals transmitted from a terminal.

By causing the engine of a vehicle to start from a remote place, it is possible to cause air conditioning for the vehicle to operate before getting into the vehicle and make the temperature in the vehicle suitable.

### SUMMARY

An object of the present disclosure is to improve convenience of remote air conditioning.

The present disclosure in its one aspect provides an information processing apparatus for controlling air conditioning for a predetermined vehicle, the information processing apparatus comprising a controller configured to execute: starting an air-conditioning mode which is a mode for causing air conditioning to operate in a state in which travel is prohibited, based on a request transmitted from a first apparatus; causing the air-conditioning mode to end when a first period passes; and extending the first period when a predetermined condition is satisfied in the vehicle.

The present disclosure in its another aspect provides an information processing method executed by an information processing apparatus for controlling air conditioning for a predetermined vehicle, the information processing method comprising the steps of: starting an air-conditioning mode which is a mode for causing air conditioning to operate in a state in which travel is prohibited, based on a request transmitted from a first apparatus; causing the air-conditioning mode to end when a first period passes; and extending the first period when a predetermined condition is satisfied in the vehicle.

Further, as another aspect, a program for causing a computer to execute the information processing method described above or a computer-readable storage medium that non-transitorily stores the program is given.

According to the present disclosure, it is possible to improve convenience of remote air conditioning.

### BRIEF DESCRIPTION OF THE DRAWINGS

FIG. 1 is a system configuration diagram of a vehicle system according to an embodiment;

FIG. 2 is a block diagram illustrating components that a vehicle has;

FIG. 3 is a block diagram illustrating a module configuration of a controller that an air-conditioning ECU has;

FIG. 4 is a block diagram illustrating components that a user terminal has;

FIG. 5 illustrates an example of air-conditioning parameters generated by the user terminal;

FIG. 6 illustrates an example of a user interface provided by the user terminal;

FIG. 7 is a flowchart for data transmitted and received among components of the vehicle system;

FIG. 8 is a flowchart of a process executed by the air-conditioning ECU in a first embodiment; and

FIG. 9 is a flowchart of a process executed by the air-conditioning ECU in a second embodiment.

### DESCRIPTION OF THE EMBODIMENTS

An aspect of the present disclosure is an information processing apparatus for controlling air conditioning for a vehicle.

Specifically, the information processing apparatus has a controller that executes: starting an air-conditioning mode which is a mode for causing air conditioning to operate in a state in which travel is prohibited, based on a request transmitted from a first apparatus; causing the air-conditioning mode to end when a first period passes; and extending the first period when a predetermined condition is satisfied in the vehicle.

The information processing apparatus may be an in-vehicle computer or may be a server apparatus or the like capable of communicating with the vehicle.

The controller that the information processing apparatus has starts the air-conditioning mode based on an instruction by a user (user of the vehicle, e.g. driver of the vehicle) transmitted via the first apparatus (for example, a mobile terminal that the user possesses). The air-conditioning mode is a mode for causing remote air conditioning to operate and is a mode for preparing a suitable in-vehicle environment by the air conditioning before the user gets into the vehicle. While the air-conditioning mode is operating, it is not possible to cause the vehicle to travel.

The remote air conditioning continues until a predetermined period set in advance passes.

However, if the expiration of the operation of remote air conditioning is uniformly set, it may cause such an inconvenience that air conditioning stops before the user has prepared for departure.

In order to cope with this, in the information processing apparatus according to the present disclosure, the period is appropriately extended when the predetermined condition is satisfied on the vehicle side. The predetermined condition may be any condition if it is possible to presume that the user is near the vehicle or that the user intends to get into the vehicle. For example, that a mobile terminal associated with the user is near the vehicle, that the user is sitting on a seat, and the like can be exemplified.

Further, the first period may be started at a timing when execution of the air-conditioning mode is started.

Further, the controller may extend the first period when the vehicle is unlocked or when a door of the vehicle is opened while the first period is counted.

Further, the controller may further extend the first period when the predetermined condition is satisfied while the first period is counted.

When the vehicle is unlocked, or a door of the vehicle opens, it can be presumed that the user intends to get into the vehicle. In such a case, it is preferable to extend the first period to avoid stop of air conditioning.

Further, the first period may be started at a timing when the vehicle is unlocked or when a door of the vehicle is opened after execution of the air-conditioning mode is started.

Further, the controller may extend the first period when the predetermined condition is satisfied while the first period is counted.

Thus, the first period may be started at a timing when the user unlocks the vehicle or opens a door.

Further, the controller periodically may judge whether the predetermined condition is satisfied or not while the first period is counted, and repeatedly extend the first period when the predetermined condition is satisfied.

According to such a configuration, it is possible to avoid stop of air conditioning as far as the predetermined condition is satisfied.

Further, the predetermined condition may be satisfied when communication is established between the vehicle and an electronic key of the vehicle. Further, the predetermined condition may be satisfied when wireless connection is made between the vehicle and a terminal associated with a driver of the vehicle.

This is because, for example, when a response to a polling signal transmitted from the vehicle side is given from the electronic key, or when the mobile terminal that the user possesses is wirelessly connected to the vehicle, it can be presumed that the user who intends to get into the vehicle is near the vehicle.

Further, the predetermined condition may be satisfied when a seat sensor of the vehicle has detected a person or an object.

This is because, in such a case, it can be presumed that baggage is being loaded or that the driver is in the vehicle.

Embodiments of the present disclosure will be explained below based on drawings. Configurations of the embodiments below are exemplifications, and the present disclosure is not limited to the configurations of the embodiments.

### First Embodiment

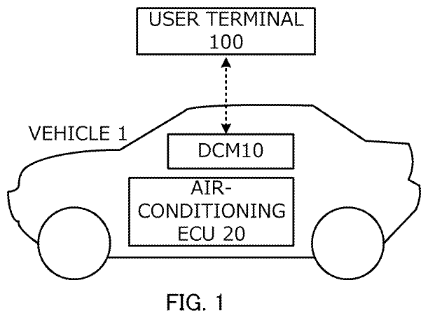

An outline of a vehicle system according to a first embodiment will be explained with reference to FIG. 1. The vehicle system according to the present embodiment is configured including a vehicle 1 and a user terminal 100.

The vehicle 1 is a connected car having a communication function. The vehicle 1 is configured including a DCM 10 which is a communication module and an air-conditioning ECU 20 which is an in-vehicle computer that manages air-conditioning apparatuses. The vehicle 1 can cause the air-conditioning apparatuses (an air conditioner, heaters and the like) to operate based on a request received from the user terminal 100. It is referred to as “remote air conditioning” that a user causes air-conditioning apparatuses to operate in advance before getting into the vehicle. In a mode for performing remote air conditioning, the vehicle system or the engine can be in an operating state, but it is not possible to cause the vehicle to travel.

The user terminal 100 is a computer (the first apparatus) capable of communicating with the vehicle 1. The user terminal 100 is configured to be capable of executing an application program for instructing the vehicle to perform a remote air conditioning operation. The user terminal 100 generates a request for causing air conditioning for the vehicle 1 to operate (hereinafter referred to as an air conditioning request) based on content of an input made by the user on the application program and transmits the air conditioning request to the vehicle 1.

Components of the system will be explained in detail.

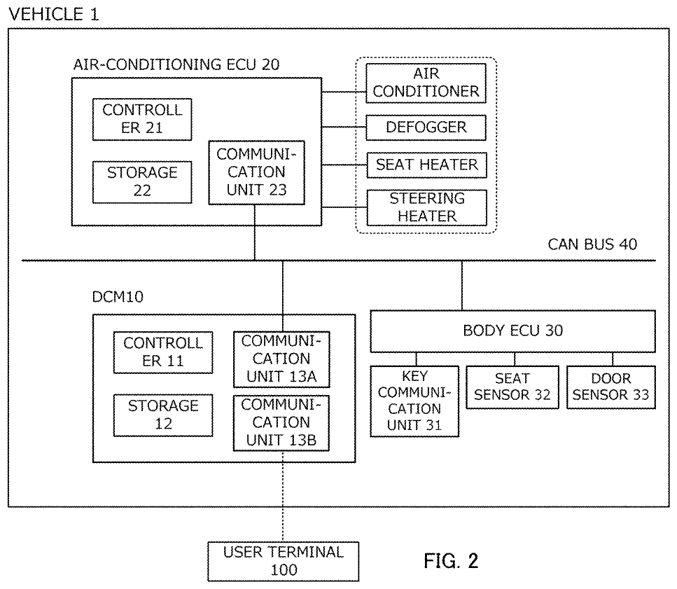

FIG. 2 is a block diagram schematically illustrating an example of a configuration of the vehicle 1 illustrated in FIG. 1. The vehicle 1 is configured including the DCM 10, the air-conditioning ECU 20 and a body ECU 30. These components are mutually connected via a CAN bus 40. Although an air-conditioning ECU and a body ECU are exemplified as ECUs (Electronic Control Units) mounted on the vehicle 1 in the present example, the vehicle 1 may be mounted with ECUs responsible for other components, such as an engine ECU, a hybrid ECU and a power train ECU.

A plurality of air conditioning apparatuses are connected to the air-conditioning ECU 20.

The DCM 10 is an interface unit that connects an in-vehicle network and a communication network outside the vehicle 1. Hereinafter, the communication network outside the vehicle 1 will be referred to simply as a network or an external network. As the external network, for example, a mobile communication network or a wide area network (such as the Internet) is given.

The DCM 10 is configured including a controller 11, a storage 12, a communication unit 13A which is an interface for performing communication with the CAN bus 40, and a communication unit 13B which is an interface for performing communication with the external network.

The DCM 10 can be configured as a computer that has processors such as a CPU (Central Processing Unit) and a GPU (Graphics Processing Unit), a main memory such as a RAM and a ROM, and auxiliary storage devices such as an EPROM, a disk drive and a removable medium. However, a part or all of functions may be realized by a hardware circuit such as an ASIC or an FPGA.

In the present embodiment, the DCM 10 is configured having the controller 11 and the storage 12. The controller 11 is an operation unit (a processor) that realizes various kinds of functions of the DCM 10 by executing a predetermined program.

The storage 12 is a memory device that includes the main memory and the auxiliary storage devices. In the auxiliary storage device, an operating system (OS), various kinds of programs, various kinds of tables and the like are stored. By loading a program stored therein to the main memory and executing the program, each function corresponding to a predetermined purpose as described later can be realized.

The DCM 10 executes a function of mediating communication between the external network and the vehicle 1. For example, when any of the ECUs that the vehicle 1 has requires communication with the external network, the DCM 10 relays data transmitted from the ECU to the external network. Further, the DCM 10 receives data transmitted from the external network and transfers the data to an appropriate ECU.

In the present embodiment, the DCM 10 executes a process of receiving a request to cause air conditioning for the vehicle 1 to operate (an air conditioning request) from the user terminal 100 and transferring the air conditioning request to the air-conditioning ECU 20 to be described later.

Furthermore, the DCM 10 can execute functions specific thereto. For example, the DCM 10 has a security system monitoring function and a telephone conversation function and can make a security report, an emergency report or the like based on a trigger that has occurred in the vehicle.

The communication unit 13A is a communication interface that connects the DCM 10 to the in-vehicle network (the CAN bus 40). The communication unit 13A executes a process of converting a message in a predetermined format generated by the controller 11 to CAN data and a process of converting received CAN data into a message in a predetermined format and transmitting the message to the controller 11.

The communication unit 13B is a communication interface that connects the DCM 10 to the external network. The communication unit 13B executes a process of converting a message in a predetermined format generated by the controller 11 to a communication packet and a process of converting a received communication packet into a message in a predetermined format and transmitting the message to the controller 11.

Next, the air-conditioning ECU 20 will be explained.

The air-conditioning ECU 20 is an electronic control unit that controls air conditioning for the vehicle 1. The plurality of air conditioning apparatuses are connected to the air-conditioning ECU 20, and the air-conditioning ECU 20 performs control of these air conditioning apparatuses based on an instruction from the user. As the plurality of air conditioning apparatuses that the vehicle 1 has, for example, a car air conditioner, a defogger (a defroster), a seat heater, a steering heater and the like can be exemplified.

In addition to causing the air conditioning apparatuses to operate, based on an operation performed on a control panel installed in the vehicle, the air-conditioning ECU 20 executes remote air conditioning based on an air conditioning request transmitted via the external network. The mode for performing remote air conditioning will be referred to as a remote air-conditioning mode. When the vehicle 1 is in the remote air-conditioning mode, travel is prohibited. When the vehicle 1 is in the remote air-conditioning mode, for example, change in a shift position, release of a parking brake, release of a steering lock and the like are prohibited.

Similarly to the DCM 10, the air-conditioning ECU 20 can be configured as a computer that has processors such as a CPU and a GPU, a main memory such as a RAM and a ROM, and auxiliary storage devices such as an EPROM, a disk drive and a removable medium.

In the present embodiment, the air-conditioning ECU 20 is configured having a controller 21, a storage 22 and a communication unit 23.

The controller 21 is an operation unit (a processor) that realizes various kinds of functions of the air-conditioning ECU 20 by executing a predetermined program.

The storage 22 is a memory device that includes the main memory and the auxiliary storage devices. Since the functions thereof are similar to those of the controller 11 and the storage 12, detailed description will be omitted.

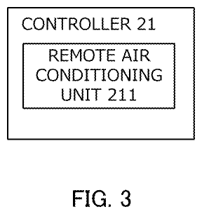

FIG. 3 is a diagram illustrating a logical configuration of the controller 21.

The controller 21 has a remote air conditioning unit 211 as a function module. The function module may be realized by executing a program stored in storage unit such as the ROM by the controller 21 (that is, the CPU and the like).

The remote air conditioning unit 211 generates a command for causing one or more air conditioning apparatuses to operate, based on a received air conditioning request. Thereby, remote air conditioning for the vehicle 1 is started. Further, the remote air conditioning unit 211 causes the remote air conditioning to stop when a predetermined condition is satisfied. A specific method will be described later.

The communication unit 23 is a communication interface that connects the air-conditioning ECU 20 to the in-vehicle network (the CAN bus 40). The communication unit 23 executes a process of converting a message in a predetermined format generated by the controller 21 to CAN data and a process of converting received CAN data into a message in a predetermined format and transmitting the message to the controller 21.

The body ECU 30 is an electronic control unit that controls a body component that the vehicle 1 has. The body ECU 30 performs control of components associated with the vehicle body, such as locking/unlocking control of the vehicle 1, power window control, seat position adjustment, security system control, seat belt control and head light control.

To the body ECU 30, a communication unit that performs communication with an electronic key (a smart key) of the vehicle (a key communication unit 31), load sensors included in seats (seat sensors 32), a sensor that detects opened/closed states of doors (a door sensor 33) and the like are connected.

The key communication unit 31 includes a unit configured to transmit radio waves in a low frequency bandwidth (for example, 100 kHz to 300 kHz) for searching for (polling) the electronic key of the vehicle and a unit configured to receive radio waves in a high frequency bandwidth (for example, 100 MHz to 1 GHz) transmitted from the electronic key. The body ECU 30 transmits a polling signal to the inside and outside of the vehicle in a predetermined cycle and receives a reply signal transmitted by the electronic key in response to the polling signal. The reply signal includes an ID specific to the electronic key, and the body ECU 30 can perform an electronic key authentication process based on the received ID. Thereby, the body ECU 30 can perform locking/unlocking of the vehicle by the electronic key, and the like. The body ECU 30 can also detect that the electronic key is inside or near the vehicle.

The seat sensors 32 are installed for a plurality of seats of the vehicle, respectively, and they are sensors that detect loads on seat surfaces. The body ECU 30 can detect that a person or an object exists on a seat based on sensor data outputted by any of the seat sensors 32.

The door sensor 33 is a sensor that acquires opened/closed states and locked states of a plurality of doors (including the hatch of the trunk in addition to the doors for getting in and out and the rear gate) that the vehicle has. The body ECU 30 can detect that any of the doors has been unlocked or opened, based on data outputted by the door sensor 33.

The CAN bus 40 is a communication bus constituting an in-vehicle network based on the CAN (Controller Area Network) protocol. Although one CAN bus 40 is exemplified in the present example, the in-vehicle network may have a plurality of communication buses. Further, the in-vehicle network may have a gateway that connects the plurality of communication bus to one another.

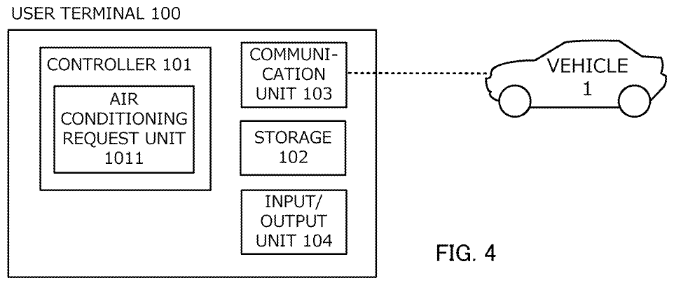

FIG. 4 is a block diagram schematically illustrating an example of a configuration of the user terminal 100 illustrated in FIG. 1.

The user terminal 100 is a mobile terminal that the user of the vehicle 1 possesses. The user terminal 100 is configured to be capable of executing the application program for instructing the vehicle to perform a remote air conditioning operation. The application program outputs a user interface for causing a set temperature for air conditioning, an apparatus to be caused to operate, and the like to be specified, and acquires content of an input made by the user. Further, the application program generates a request for causing remote air conditioning to operate (an air conditioning request) based on the content of the input and transmits the request to the vehicle 1.

The user terminal 100 can be configured with a general-purpose computer. That is, the user terminal 100 can be configured as a computer that has processors such as a CPU and a GPU, a main memory such as a RAM and a ROM, and auxiliary storage devices such as an EPROM, a hard disk drive and a removable medium. In the auxiliary storage device, an operating system (OS), various kinds of programs, various kinds of tables and the like are stored. By executing a program stored therein, each of functions corresponding to a predetermined purpose as described later can be realized. However, a part or all of the functions may be realized by a hardware circuit such as an ASIC or an FPGA.

The user terminal 100 is configured having a controller 101, a storage 102, a communication unit 103 and an input/output unit 104.

The controller 101 is a unit that is responsible for control of the user terminal 100. The controller 101 is configured with information processing units, for example, a CPU (Central Processing Unit), a GPU (Graphics Processing Unit) and the like.

The controller 101 has an air conditioning request unit 1011 as a function module. The function module may be realized by executing a program stored in storage unit such as the ROM by the CPU.

Based on an operation performed by the user, the air conditioning request unit 1011 generates a request for causing specified remote air conditioning for the vehicle 1 to operate (an air conditioning request) and transmits the request to the vehicle 1. The air conditioning request unit 1011 is realized by the application program described above. The air conditioning request unit 1011 generates a user interface screen and provides the user interface screen for the user. Further, the air conditioning request unit 1011 acquires information inputted via the user interface screen and generates an air conditioning request based on the information. The generated air conditioning request is transmitted to the DCM 10 mounted on the target vehicle via the network.

The storage 102 is a unit configured to store information and is configured with a storage medium such as a RAM, a magnetic disk or a flash memory. In the storage 102, various kinds of programs to be executed by the controller 101 and data and the like to be used by the programs are stored. Further, the storage 102 stores data about the vehicle 1 (for example, an identifier of the vehicle 1, identification information about the DCM 10 and the like).

The communication unit 103 is an interface for connecting the user terminal 100 to the network. The communication unit 103 can communicate with the vehicle 1, for example, via the Internet, a mobile communication network or the like.

The input/output unit 104 is a unit configured to accept an input operation performed by the user and presenting information to the user. Specifically, the input/output unit 104 is configured with a touch panel and control unit therefor, and a liquid crystal display and control unit therefor. The touch panel and the liquid crystal display are configured with one touch panel display in the present embodiment. Further, the input/output unit 104 may have a speaker or the like for outputting voice.

Next, details of an air conditioning request generated by the user terminal 100 will be explained.

In order to cause air conditioning for the vehicle to operate, it is necessary to specify an air-conditioning mode, a set temperature, air conditioning apparatuses caused to operate, and the like. Pieces of information specifying these will be referred to as air-conditioning parameters.

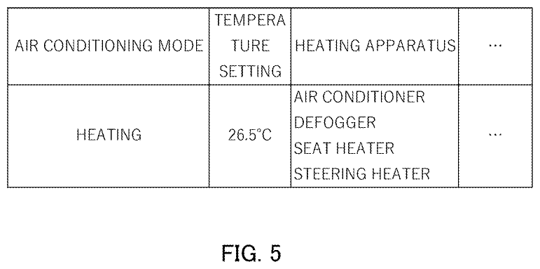

FIG. 5 illustrates an example of the air-conditioning parameters. The air-conditioning parameters include pieces of information specifying an air-conditioning mode, a set temperature and air-conditioning apparatuses to be caused to operate, and the like. The user terminal 100 adds the identifier of the target vehicle and data instructing air conditioning to start or end to the air-conditioning parameters and transmits the air-conditioning parameters and the data to the vehicle 1 as an air conditioning request.

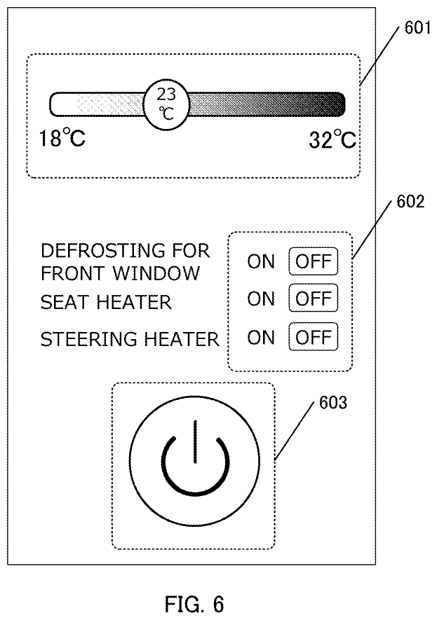

FIG. 6 illustrates an example of a user interface for specifying the illustrated air-conditioning parameters. The illustrated user interface is configured including a slider for setting a temperature (reference sign 601), a part for specifying an air-conditioning apparatus to be caused to operate (reference sign 602), a button for transmitting a request (reference sign 603) and the like.

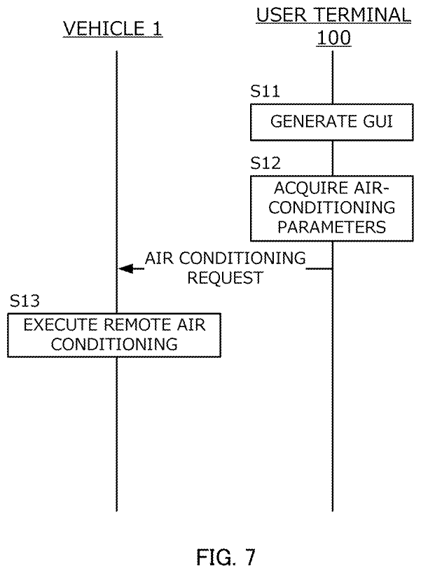

FIG. 7 is a flowchart illustrating a flow of data among the components included in the system.

When the user who desires remote air conditioning for the vehicle starts the application program on the user terminal 100, the user terminal 100 (the air conditioning request unit 1011) generates and outputs a user interface (step S11).

At step S12, the air conditioning request unit 1011 acquires air-conditioning parameters specified by the user via the generated user interface, generates an air conditioning request that includes the air-conditioning parameters and transmits the air conditioning request to the vehicle 1.

At step S13, the DCM 10 of the target vehicle receives the air conditioning request and executes remote air conditioning based on the air conditioning request. Specifically, the DCM 10 transfers the received air conditioning request to the air-conditioning ECU 20, and the air-conditioning ECU 20 causes various air-conditioning apparatuses to operate based on the air conditioning request.

When receiving the air conditioning request, the air-conditioning ECU 20 causes remote air conditioning to operate, with a predetermined time as an upper limit. When performing air conditioning for the vehicle, it is not preferable to perform operation for a longer time than necessary because the engine, an electric compressor and the like are caused to operate. Therefore, the air-conditioning ECU 20 sets the upper limit (for example, 20 minutes) for an operation time of remote air conditioning.

However, if the operation time is uniformly restricted, it may happen that remote air conditioning stops before the vehicle starts. For example, in the case of requiring much time to prepare for departure when many people get into the car or in the case of loading baggage, remote air conditioning may stop before the preparation for departure is completed.

Therefore, in the present embodiment, the air-conditioning ECU 20 acquires information from the body ECU 30 and, if it is indicated that the user is going to get into the vehicle 1, executes a process of causing the operation time of remote air conditioning to be extended. Specifically, when any of the following three conditions is satisfied, it is judged that the user intends to get into the vehicle 1, and the operation time of remote air conditioning is caused to be extended.

(1) When the electronic key exists near the vehicle 1

This is because, when the electronic key exists inside or near the vehicle 1, it can be presumed that the user is inside or near the vehicle. For example, it is possible to judge whether or not the electronic key is inside or near the vehicle, based on whether or not a response to a polling signal transmitted by the key communication unit 31 has been transmitted from the electronic key.

(2) When any of the seat sensors 32 of the vehicle 1 has detected a person or an object

This is because, when any of the seat sensors 32 of the vehicle 1 has detected a person or an object, it can be presumed that baggage is being loaded or that the driver or a passenger is in the vehicle. For example, sensor data outputted by any of the seat sensors 32 indicates a load larger than a predetermined value, it can be judged that a person or baggage is on a corresponding seat.

(3) When wireless connection is established between the vehicle 1 and the user terminal 100

This is because, when the vehicle and the user terminal is wirelessly connected (typically, wireless connection by a near field communication standard such as Bluetooth (registered trademark)), it can be presumed that the user is in or near the vehicle. A connection destination of the user terminal 100 may be an ECU that the vehicle 1 has or may be an information terminal (a navigation apparatus, an infotainment apparatus or the like) mounted on the vehicle 1.

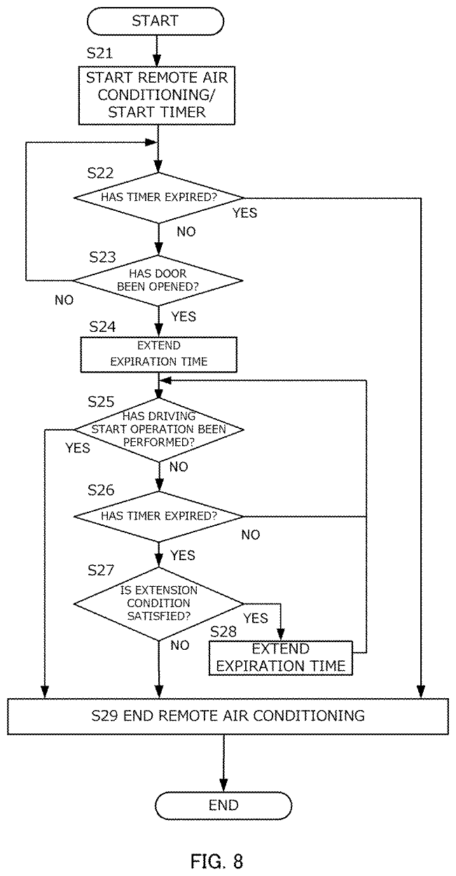

The process executed by the air-conditioning ECU 20 will be explained in more detail. FIG. 8 is a flowchart of the process that the air-conditioning ECU 20 (the remote air conditioning unit 211), which has received an air conditioning request, executes at step S13.

First, at step S21, remote air conditioning is started. At this step, air-conditioning apparatuses which the vehicle has start operation based on air-conditioning parameters specified by the user.

Further, at this step, a timer for causing the operation of the remote air conditioning to automatically stop is caused to start (in other words, counting of the “first period” is caused to start). The timer expires when a predetermined time (in this example, twenty minutes) passes. When the timer expires, remote the air conditioning automatically stops.

At step S21, the air-conditioning ECU 20 may generate data notifying that the operation of the air-conditioning apparatuses has started (answer back data) and transmit the data to the user terminal 100. Thereby, it can be notified to the user of the vehicle that the remote air conditioning has normally operated.

At step S22, it is judged whether the timer has expired (whether the “first period” has passed) or not. Here, when the timer has expired (that is, when twenty minutes have passed without the user doing anything), the process transitions to step S29, and the remote air conditioning ends.

If a negative judgment is made at step S22, the process transitions to step S23, and it is judged whether the door of the vehicle has been opened or not. Here, when a positive judgment is made (when the door of the vehicle has been opened), the process transitions to step S24. When the door has not been opened, the process returns to step S22. Although it is judged whether the door of the vehicle has been opened or not in this example, it may be judged whether the vehicle has been unlocked or not.

At step S24, an expiration time set in advance is extended (for example, extended by two minutes). Thereby, it is possible to prevent the remote air conditioning from ending even though the user is going to get into the vehicle.

At step S25, it is judged whether a driving starting operation by the user has been performed or not. The driving starting operation is, for example, an operation of turning on the ignition, an operation of pressing the main switch of the vehicle. When a positive judgment is made at this step, the process transitions to step S29, and the remote air conditioning ends. In this case, the vehicle 1 transitions to a mode for driving while keeping the air-conditioning apparatuses operating.

When the driving starting operation is not performed at step S25, it is judged whether the timer has expired (whether the “first period” has passed” or not) at step S26. Here, when the timer has not expired, the process returns to step S25. When the timer has expired, the process transitions to step S27, and it is judged whether any of the extension conditions is satisfied or not on the vehicle side.

The extension condition is any of (1) to (3) described above. When at least any of (1) to (3) described above is satisfied, it is considered that the user intends to get into the vehicle, and the expiration time of the timer is extended (for example, extended by two minutes) at step S28. Thereby, even when there is time before the vehicle starts after the door is opened, the operation of remote air conditioning can be maintained. When a state in which none of (1) to (3) described above is satisfied continues, remote air conditioning stops when the timer expires.

As explained above, in the vehicle system according to the present embodiment, the expiration time of the timer for causing remote air conditioning to end is repeatedly extended, based on whether or not a predetermined condition is satisfied on the vehicle side after the vehicle is unlocked. According to such a configuration, it becomes possible to maintain the operation of remote air conditioning even when it is not possible to start the vehicle immediately after unlocking the vehicle, and it is possible to enhance usability.

### Second Embodiment

Although there is one kind of timer in the first embodiment, two timers, a first time that starts at a timing when remote air conditioning is started and a second timer that starts at a timing when the vehicle is unlocked, or a door is opened, may be used together. A second embodiment is an embodiment in which these two timers are used together to cause remote air conditioning to operate.

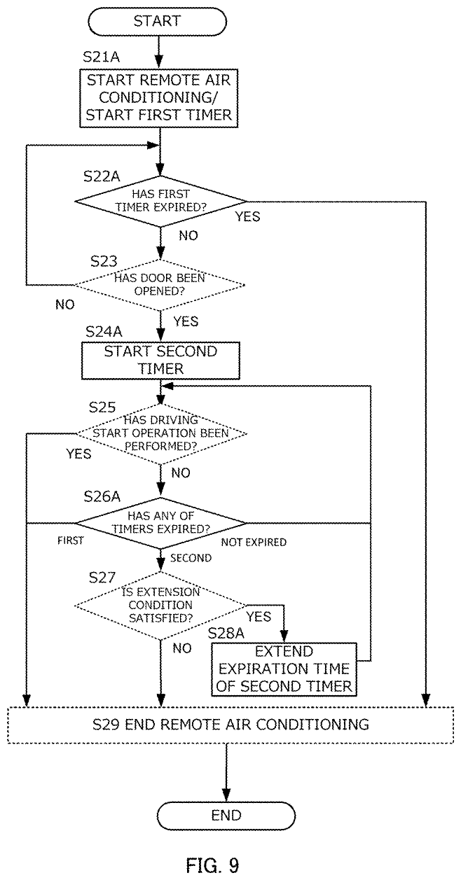

FIG. 9 is a flowchart of a process executed by the air-conditioning ECU 20 in the second embodiment. Since steps surrounded by dotted lines are similar to steps of the first embodiment, description will be omitted.

In the second embodiment, at step S21A, remote air conditioning is started, and the first timer is caused to start. The first timer is a timer that specifies the maximum time of remote air conditioning, and the expiration time is fixed (for example, twenty minutes).

At step S22A, it is judged whether the first timer has expired or not. Here, when the first timer has expired (that is, twenty minutes have passed without the user doing anything), the process transitions to step S29, and the remote air conditioning ends.

Further, when the door of the vehicle is opened, the second timer is caused to start at step S24A. The second timer is a timer that starts at the timing when the door of the vehicle is opened and is a timer that counts the “first period”.

At step S26A, it is judged whether any of the first and second timers has expired or not. Here, when neither of the timers has expired, the process returns to step S25.

When the first timer has expired, it means that the maximum time of remote air conditioning has been reached, and, therefore, the process transitions to step S29, where the remote air conditioning is caused to stop.

When the second timer has expired (that is, the “first period” has passed), the process transitions to step S27, and it is judged whether any of the extension conditions is satisfied on the vehicle side or not. Here, when the extension condition is satisfied on the vehicle side, the expiration time of the second timer is extended (step S28A).

In the second embodiment, remote air conditioning does not operate after the expiration time of the first timer. That is, it is possible to, when the vehicle does not start for a long time even though any of the extension conditions is satisfied on the vehicle side, cause remote air conditioning to stop.

(Modifications)

The embodiments described above are mere examples, and the present disclosure can be appropriately changed and practiced within a range not departing from the spirit of the disclosure.

For example, the processes and units explained in the present disclosure can be freely combined and implemented as far as no technical contradiction occurs.

Further, although the user terminal 100 capable of communicating with the vehicle 1 is exemplified as the “first apparatus” in the explanation of the embodiments, remote air conditioning may be instructed to perform by a key fob or a portable machine (including what also serves as the electronic key of the vehicle).

Further, although the air-conditioning ECU 20 manages the timer for causing remote air conditioning to stop in the explanation of the embodiments, an in-vehicle computer other than an air conditioning ECU or a computer installed outside the vehicle may manage the timer. For example, a server apparatus capable of communicating with the vehicle 1 may manage the timer and instruct the vehicle 1 to start and end remote air conditioning. In this case, the vehicle 1 may cyclically transmit information about the location of the electronic key, information about locked/unlocked states, information about an output of each seat sensor, and the like to the server apparatus, and the server apparatus may execute the process illustrated in FIG. 8. Further, in this case, the user terminal 100 may transmit an air conditioning request to the vehicle 1 via the server apparatus.

In addition, the processing described as being performed by one device may be shared and executed by a plurality of devices. Alternatively, the processing described as being performed by different devices may be executed by one device. In a computer system, what hardware configuration (server configuration) realizes each function can be flexibly changed.

The present disclosure can also be realized by supplying a computer program including the functions described in the above embodiments to a computer and causing one or more processors included in the computer to read and execute the program. Such a computer program may be provided to the computer by a non-transitory computer-readable storage medium connectable to a system bus of the computer, or may be provided to the computer via a network. Examples of non-transitory computer readable storage media include: any type of disk such as a magnetic disk (floppy (registered trademark) disk, hard disk drive (HDD), etc.), an optical disk (CD-ROM, DVD disk, Blu-ray disk, etc.); and any type of medium suitable for storing electronic instructions, such as read-only memory (ROM), random access memory (RAM), EPROM, EEPROM, magnetic cards, flash memory, and optical cards.

What is claimed is:

1. An information processing apparatus for controlling air conditioning for a predetermined vehicle, the information processing apparatus comprising a controller configured to execute:
starting an air-conditioning mode which is a mode for causing air conditioning to operate in a state in which travel is prohibited, based on a request transmitted from a first apparatus;
causing the air-conditioning mode to end when a first period passes; and
extending the first period when a predetermined condition is satisfied in the vehicle.

2. The information processing apparatus according to claim 1, wherein
the first period is started at a timing when execution of the air-conditioning mode is started.

3. The information processing apparatus according to claim 2, wherein
the controller extends the first period when the vehicle is unlocked or when a door of the vehicle is opened while the first period is counted.

4. The information processing apparatus according to claim 3, wherein
the controller further extends the first period when the predetermined condition is satisfied while the first period is counted.

5. The information processing apparatus according to claim 1, wherein
the first period is started at a timing when the vehicle is unlocked or when a door of the vehicle is opened after execution of the air-conditioning mode is started.

6. The information processing apparatus according to claim 5, wherein
the controller extends the first period when the predetermined condition is satisfied while the first period is counted.

7. The information processing apparatus according to claim 5, wherein
the controller periodically judges whether the predetermined condition is satisfied or not while the first period is counted, and repeatedly extends the first period when the predetermined condition is satisfied.

8. The information processing apparatus according to claim 1, wherein
the predetermined condition is satisfied when communication is established between the vehicle and an electronic key of the vehicle.

9. The information processing apparatus according to claim 1, wherein
the predetermined condition is satisfied when a seat sensor of the vehicle has detected a person or an object.

10. The information processing apparatus according to claim 1, wherein
the predetermined condition is satisfied when wireless connection is made between the vehicle and a terminal associated with a driver of the vehicle.

11. An information processing method executed by an information processing apparatus for controlling air conditioning for a predetermined vehicle, the information processing method comprising the steps of:
starting an air-conditioning mode which is a mode for causing air conditioning to operate in a state in which travel is prohibited, based on a request transmitted from a first apparatus;
causing the air-conditioning mode to end when a first period passes; and
extending the first period when a predetermined condition is satisfied in the vehicle.

12. The information processing method according to claim 11, wherein
the first period is started at a timing when execution of the air-conditioning mode is started.

13. The information processing method according to claim 12, wherein
the first period is extended when the vehicle is unlocked or when a door of the vehicle is opened while the first period is counted.

14. The information processing method according to claim 13, wherein
the first period is further extended when the predetermined condition is satisfied while the first period is counted.

15. The information processing method according to claim 11, wherein
the first period is started at a timing when the vehicle is unlocked or when a door of the vehicle is opened after execution of the air-conditioning mode is started; and
the first period is extended when the predetermined condition is satisfied while the first period is counted.

16. The information processing method according to claim 15, wherein
it is periodically judged whether the predetermined condition is satisfied or not while the first period is counted, and the first period is repeatedly extended when the predetermined condition is satisfied.

17. The information processing method according to claim 11, wherein
the predetermined condition is satisfied when communication is established between the vehicle and an electronic key of the vehicle.

18. The information processing method according to claim 11, wherein
the predetermined condition is satisfied when a seat sensor of the vehicle has detected a person or an object.

19. The information processing method according to claim 11, wherein
the predetermined condition is satisfied when wireless connection is made between the vehicle and a terminal associated with a driver of the vehicle.

20. A non-transitory computer readable storing medium recording a computer program for causing a computer to perform an information processing method according to claim 11.
